(19) United States
(12) Patent Application Publication
(10) Pub. No.: US 2025/0334796 A1
(43) Pub. Date: Oct. 30, 2025

(54) EYE-TRACKING SYSTEM

(71) Applicant: Apple Inc., Cupertino, CA (US)

(72) Inventors: Michael J Oudenhoven, San Francisco, CA (US); Brian S Lau, Seattle, WA (US); Leah Cohen, San Francisco, CA (US)

(21) Appl. No.: 18/870,221

(22) PCT Filed: Jun. 30, 2023
(86) PCT No.: PCT/US2023/069463

§ 371 Date: Nov. 27, 2024

Related U.S. Application Data
(60) Provisional application No. 63/367,478, filed on Jun. 30, 2022.

(51) Int. Cl. G02B 27/00; G02B 27/01

(52) U.S. Cl. CPC G02B 27/0093; G02B 27/0172; G02B 27/0176; G02B 2027/0138; G02B 2027/0158; G02B 2027/0178

(57) ABSTRACT

An optical device can include a first securement arm, a second securement arm, and a lens frame defining a lens aperture and including a nose bridge, the lens frame connected to the first and second securement arms. The optical device can also include an eye-tracking camera mounted to a platform extending from the lens frame, the platform disposed proximate the nose bridge. An electronic component is disposed in the lens frame, the electronic component electronically connected to the camera.

### CROSS-REFERENCE TO RELATED APPLICATION(S)

This application is a National Stage filing based off of PCT Application No. PCT/US2023/069463, filed 30 Jun. 2023, and entitled “EYE-TRACKING SYSTEM” which claims priority to U.S. Provisional Patent Application No. 63/367,478, filed 30 Jun. 2022, and entitled “EYE-TRACKING SYSTEM,” the entire disclosure of which is hereby incorporated by reference.

### FIELD

The described embodiments relate generally to smart glasses. More particularly, the present embodiments relate to wearable eye-tracking devices and systems.

### BACKGROUND

Eye-tracking is a process for measuring the eye movement or the eye-gaze direction of an individual. Various eye-tracking technologies have been developed for use in a variety of applications, such as vision research, human computer interfaces, tele-surgery, advertising research, visual communication, and various military applications. Wearable devices and systems benefit from eye-tracking information and function as an advantageous platform for eye-tracking because eye measurements collected from a platform close to one or both eyes reduce measurement errors generated by head movements and other sources. Prior wearable systems that incorporated eye-tracking systems were typically bulky and expensive due to inconvenient camera locations or the use of camera platforms that are obtrusive to the vision of the user.

### SUMMARY

The present disclosure relates generally to wearable electronic devices and eye-tracking systems. In particular, the present disclosure relates to optical devices including an eye-tracking system. In one example, the present disclosure includes an optical device that includes a first securement arm, a second securement arm, and a lens frame defining a lens aperture and including a nose bridge. The lens frame can be connected to the first and second securement arms. The optical device can further include an eye-tracking camera mounted to a platform extending from the lens frame, the platform disposed proximate the nose bridge.

In some examples, an electronic component can be disposed in the lens frame, the electronic component electronically connected to the camera. In some examples, the electronic component can include a battery, a sensor, a communication module, or a processor. The electronic component can be disposed in the nose bridge of the optical device. In some examples, a lens can be disposed in the lens aperture, the lens include an inner surface. A distance between the eye-tracking camera and a surface of an eye during use is less than a distance between the inner surface of the lens and the surface of the eye. In some examples, the optical device can include a nose pad connected to the platform. The nose pad can include an interchangeable nose pad. In some examples, the interchangeable nose pad can include a clamp, a snap, or a magnet. In some examples, the platform can be removably connected to the lens frame.

According to some aspects, an eye-tracking system can include an optical device having a frame defining a nasal region and a lens. The eye-tracking system can also include a camera disposed in the nasal region and a processor connected to the camera. The processor can be configured to receive an image from the camera and identify a property of an eye based on the received image.

In some examples, the camera can include an infrared camera. In some examples, the camera can be oriented at a horizontal angle between about 30° and about 50° relative to the lens and a center of an eye during use. In some examples, the camera can be oriented at a vertical angle between about 0° and about 30° relative to the lens and a center of an eye during use. The camera can include a resolution between about 320 and about 640 pixels. In some examples, the camera can include a lens having a diameter between about 2 mm and about 4 mm. In some examples, the camera can be a first camera and the eye-tracking system further includes a second camera disposed in the nasal region. In some examples, the processor can be disposed in the frame of the optical device.

A head mounted display (HMD) can include a frame defining a platform in a nasal region of the frame, the platform extending from the nasal region and a lens disposed in a frame. The smart eyeglass system can also include a nose pad secured to the frame, a camera mounted to the platform adjacent the nose pad and a sensor responsive to an eye movement of the wearer. In some examples, the platform and the nose pad can be calibrated to a face of the wearer. The lens can include a prescription lens. In some examples, the HMD can further include a processor connected to the camera. The processor can receive an image from the camera and determine the gaze point of an eye.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 shows a front view of a user wearing a smart eyeglass system.

FIG. 2 shows a back view of an optical device with an eye-tracking camera and an electronic component disposed in a frame of an assembly of the optical device.

FIG. 3 shows an enlarged view of an optical device of an eye-tracking system.

FIG. 4 shows an eye-tracking camera mounted to a platform extending from the lens frame.

FIG. 5 shows a cross-sectional view of the eye-tracking camera of FIG. 4.

FIG. 6 shows a top view of an optical device with a platform extending from the lens frame.

FIG. 7 shows an enlarged view of the lens frame of an optical device with the platform being removably connected to the lens frame.

FIG. 8 shows a back view of an optical device with an eye-tracking system including a first camera and a second camera disposed in the frame of the optical device; a processor is also disposed in the frame.

FIG. 9 shows a front view of a user's eye from a camera facing a wearer of an eye-tracking system.

FIG. 10A shows a top view of a user wearing an eye-tracking system and an angle orientation between the camera, the user's eye, and the lens of the optical device.

FIG. 10B shows a side view of a user wearing an eye-tracking system and an angle orientation between the camera, the user's eye, and the lens of the optical device.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The following disclosure relates to an eye-tracking system (also referred to as smart glasses, a smart eyeglass system, or an optical device) that is wearable, similar to a pair of eyeglasses. Eye-tracking can include capturing and/or measuring either the point of gaze (where one is looking) or the motion of an eye relative to the head. The retina of the eye includes an area of dense nerves and high-visual acuity called the fovea. The lens of the eye focuses light on the fovea, and muscles moves the eyes to direct the lens and fovea where they want to look.

An eye-tracking device for measuring eye positions and eye movement can be used in research on the visual system, in psychology, as an input device for human-computer interaction, virtual and mixed or augmented reality (VR/AR) applications, and in product design. Gaze position is the primary indicator of human attention and a basis for subsequent analysis metrics (dwell time, glance, area of interest, etc.). The point of gaze estimated from the information captured by the eye-tracking system can, for example, allow gaze-based interaction with other devices and/or displays. In some examples, eye-tracking systems can be used for rehabilitative and assistive applications (e.g., to control of wheelchairs, robotic arms and prostheses). The eye-tracking system can detect position and movements of the user's eyes or detect other information about the eyes such as pupil dilation. Other applications can include, but are not limited to, creation of eye image animations used for avatars in a VR/AR environment.

The disclosed systems and devices solve fundamental challenges faced by previous eye-tracking systems by providing a number of advantages. First, the position of the camera allows a clear and unobstructed view of the eye from an angle that can best capture the gaze of the wearer or user. For example, eyelids and eyelashes can obscure the view from the eye-tracking camera. If enough of the view is obscured, tracking will not properly function, even though the wearer can still see.

Additionally, the present eye-tracking system accurately performs eye-tracking without obstructing the view of the wearer. By trying to achieve the best angle for the camera, traditional eye-tracking devices place the camera in a location that partially obstructs the view of the wearer. For example, traditional systems modify the frame to include a camera housing that is placed over a portion of the lens, which can distract the wearer and/or obscure a portion of the field of vision. The present eye-tracking system seamlessly positions the eye-tracking camera in a way that does not impact or otherwise detract from the user's view.

Moreover, the components of the present eye-tracking system are light-weight and/or small. As such, the present eye-tracking system addresses the problem of an unbalanced weight distribution that could be experienced by a user while wearing the smart glasses. The nature of smart glasses or head mounted displays (HMDs) require components within the system that are not present in ordinary prescription or non-smart glasses. These components can be heavy and possibly cause the center of mass of the eye-tracking system to be different than glasses. This can result in the wearer feeling discomfort or experiencing muscle fatigue due to the rotational torque put on the wearer's head and neck. The present eye-tracking system addresses and/or minimizes user discomfort by using small and lightweight electronic components integrated into the frame of the optical device to make the effects negligible. Each of these benefits are discussed in further detail below.

While the present systems and methods are described in the context of smart glasses, the systems and methods can be incorporated into any head mounted display (HMD) including, but in no way limited to, smart glasses, virtual reality goggles or headsets, and any other head-mounted system that includes a visual display positioned near the eye of a user.

In some examples, eye-tracking systems require a calibration, which is a method of algorithmically associating the physical position of the eye with the point in space that the participant is looking at (gaze), because there are variations in eye size, nose shape, fovea position, and general physiology that should be taken into consideration for each individual. To a degree, gaze position is a function of the perception of the participant. A calibration typically involves the participant looking at fixed, known points in the visual field. For example, these can be displayed on a computer screen for a screen-based eye-tracking system, or other suitable physical or digital displays for customization and/or tuning for the eye-tracking system and the wearer. Once calibrated, the eye-tracking system can accurately identify the gaze of the user's eye and can then use that information for any number of functionalities, including, but in no way limited to, providing an input for smart glasses or HMDs, identifying a user intent, interacting with a user in an augmented reality environment, and the like.

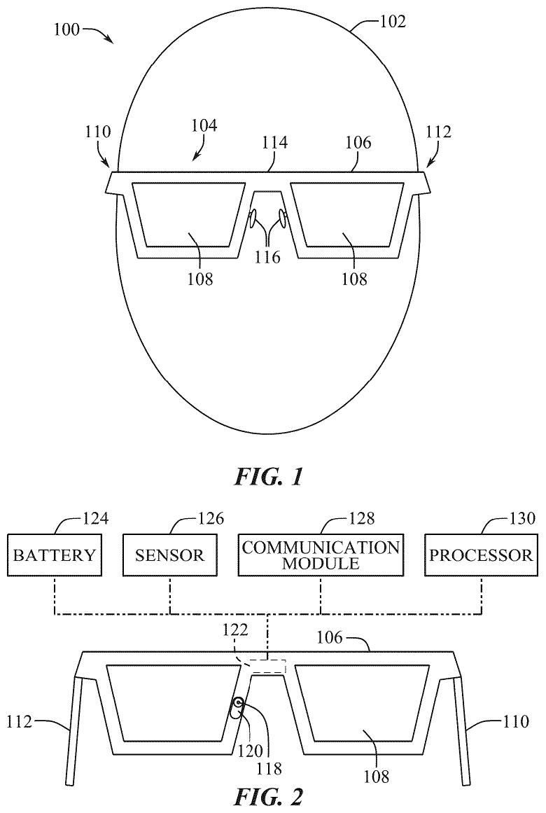

These and other embodiments are discussed below with reference to FIGS. 1-10. However, those skilled in the art will readily appreciate that the detailed description given herein with respect to these Figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

The devices, systems, and methods herein provide a wearable eye-tracking device that is optimized for mobile use in a variety of applications, including those where the benefit of eye-tracking can augment the use of other mobile devices and systems currently deployed. The devices, systems, and methods herein can be optimized and/or sufficiently robust for everyday use including outdoor or other environmental conditions, thereby expanding the number of applications where the benefit of eye and/or gaze-tracking may be employed.

FIG. 1 shows a smart eyeglass system that includes an optical device 100 on a wearer 102. The optical device 100 can include an assembly 104. In some examples, all the components of an eye-tracking system can be included in the assembly 104. The assembly 104 can include a lens frame 106. The lens frame defines an aperture for a lens 108. In some examples, the lens 108 can include a first lens and a second lens disposed in the lens frame 106. The lens 108 can include a prescription lens. In other examples, the lens 108 can include sunglass lens, multifocal, progressive lens, polarization filters, blue light protection, virtual reality screen, and other suitable prescriptions or features. In some examples, the lens 108 can include glass, plastic, polycarbonate, or other suitable material.

In some examples, the assembly 104 can include a first securement arm 110 and a second securement arm 112 that extend from the lens frame 106. The first securement arm 110 and the second securement arm 112 connect to the frame proximate the temples of the wearer 102 and extend over the ears of the wearer 102 for stability and balance. The assembly 104 can further include a nose bridge 114. In some examples, the nose bridge 114 can be integrated into the lens frame 106 or in other examples the nose bridge 114 can join the portions of the lens frame 106 defining the aperture for lenses 108 together.

In some examples, the assembly 104 can include a nose pad 116. The nose pad 116 can include one or multiple pieces configured under the nose bridge 114 that contacts the user's nose for a more comfortable and secure fit. In some examples, the nose pad 116 can be connected to the lens frame 106 or the nose pad 116 can be integrated into the lens frame 106. In some examples, the nose pad 116 can be interchangeable.

As shown in FIG. 1, the smart eyeglass system is generally configured similar to traditional spectacles or eyeglasses. Optionally, one or more components of the optical device 100 may be interchangeable (e.g., to allow different size, shape, and/or other configurations of components to be exchanged). For example, the assembly 104 can include components from a modular kit, as desired based on a particular individual user. For example, the lens 108 can be replaced with a different lens to correspond to a different user's prescription or to correspond to the activity of the user. Alternatively, the assembly 104 can be assembled according to measurements provided to a supplier and further customized by interchangeable portions (e.g., nose pads 116) as required by the wearer 102. In some examples, the optical device 100 can be configured as a helmet, a pair of goggles, or other wearable device (not shown). Multiple design solutions are envisioned for integration into goggles, masks, sunglasses, HMDs, and other suitable embodiments.

Any of the features, components, and/or parts, including the arrangements and configurations thereof shown in FIG. 1 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 1. Further details of the present eye-tracking systems and methods are provided below with reference to FIG. 2.

FIG. 2 shows a back view of the optical device 100 with an eye-tracking camera 118 disposed in the lens frame 106. The eye-tracking camera 118 can be mounted to a platform 120 that extends from the lens frame 106 towards the face of the wearer (e.g., wearer 102). The lens frame 106 can define a nasal region and the lens 108. In some examples, the platform 120 can be connected to the lens frame 106 by any suitable connector or can be integrated into the lens frame 106. The platform 120 can be disposed in the nasal region proximate the nose bridge 114. The eye-tracking camera 118 can be mounted in the nasal region near the nose bridge 114 and on the platform 120 so that the eye-tracking camera 118 has an unobstructed view of the eye of the wearer 102. The positioning in the nasal region near the nose bridge 114 can provide a good angle to the parts of the eye required for tracking without obstruction from the eye lashes or other impediments. The platform 120 extends the camera closer to the eye of the wearer 102 so that the lens 108 or the frame 106 does not obstruct the camera 118.

FIG. 2 further shows an electronic component 122 disposed in the lens frame 106. Specifically, the electronic component 122 is disposed within the nose bridge 114. The electronic component 122 can be electronically connected to the camera 118. In some examples, the electronic component 122 can include at least one of a battery 124, a sensor 126, a communication module 128, or a processor 130. In one example, the electronic component 122 can include a battery 124. The battery 124 can be configured to power the camera and other electronic features of the optical device 100 of the eye-tracking system. In some examples, the battery 124 can be rechargeable and/or replaceable. The battery 124 can be lithium ion, alkaline, nickel metal hydride, or any suitable type of battery.

In some examples, the electronic component 122 can include a sensor 126. The sensor can detect, and be responsive to, an eye movement of the wearer. While not shown, in some examples, the electronic component 122 can include one or more sensors 126, for example located on external surfaces of the lens frame 106 or the nose pads 116. The sensor 126 can collect information about the wearer 102 or the wearer's external environment (e.g., depth information, lighting information, etc.). The sensor 126 can provide the collected information to a processor disposed within the assembly 104 or remotely connected to the optical device 100. The processor can receive an image from the camera 118 and determine the gaze point of the eye of the wearer.

In some examples, the optical device 100 can include an ambient light sensor, which can be used by the processor 130 to regulate a light source (not shown) for responding to indoor and/or outdoor applications in real-time. In some examples, when the processor 130 determines, based on the ambient light sensor, that ambient light is sufficient, the light source can be switched off or remain inactive, while if the ambient light is insufficient, the light source can be activated as needed for a desired eye-tracking method. Other sensors can be included. For example, an impact sensor or temperature sensor can be included to power the eye-tracking system off if ambient conditions threaten the function of the eye-tracking system. In some examples, the sensor 126 can include a sleep mode that detects when the eye-tracking system is not needed and shuts off the system to preserve battery life.

In some examples, the optical device 100 can include a communication module 128. The communication module 128 can be configured to communicate with the camera 118 and/or an electronically connected device (not shown) via a wired or wireless connection. The communication module 128 can include a printed circuit board (PCB) equipped with erasable programmable read-only memory (EPROM) for memory of at least data collected by the camera 118. The communication module 128 can send notifications or alerts to other electronic devices. For example, the communication module 128 can send notifications, information, or alerts to a smart device via BLUETOOTH, or via WI-FI. The communication module 128 can be powered by an external or internal battery, such as the battery 124 described above. The communication module 128 can include hardware, software, or both. For example, the communication module 128 can provide one or more interfaces for communication (such as, for example, packet-based communication) between the optical device 100 and one or more networks. For example, the communication module 128 can include a network interface controller (NIC) or network adapter for communicating with an Ethernet or other wire-based network or a wireless NIC (WNIC) or wireless adapter for communicating with a wireless network, such as a WI-FI. As discussed above, in some examples, the communications module 128 can enable the eye-tracking system and the optical device 100 to communicate with and/or control the operations of the smart eyeglass system.

In some examples, the electronic component 122 of the optical device 100 can include a processor 130. In some examples, the processor 130 can include hardware for executing instructions (e.g., instructions for carrying out one or more portions of any of the actions disclosed herein), such as those making up an eye-tracking system or smart eyeglass system. For example, to execute instructions, the processor 130 can retrieve instructions from an internal register, an internal cache, memory, or a storage device and decode and execute them.

In some examples, the processor 130 can be configured to perform any of the actions disclosed herein and/or cause one or more portions of the eye-tracking system or optical device 100 to perform at least one of the acts disclosed herein. Such configuration can include one or more operational programs (e.g., computer program products) that are executable by the processor 130. For example, the processor 130 can be configured to analyze the images received from the camera and calculate a gaze point of the eye of the wearer 102. In some examples, the processor 130 can receive the image from the camera and identify another property of an eye.

In some examples, the property of an eye can include persistence of vision, reflection, refraction, dispersion, absorption, polarization, and scattering or diffraction of light within the eye. Other properties that can be identified can include, but are in no way limited to, the field of view, the dynamic range of the eye, and movement of the eye, pupil dilation and/or constriction, or other relevant property. The processor 130 can track the motion and gaze of the user's eyes and/or other properties as noted above, and can convert the property into system control commands.

Any of the features, components, and/or parts, including the arrangements and configurations thereof shown in FIG. 2 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 2. Further details of the present eye-tracking systems and methods are provided below with reference to FIG. 3.

Referring now to FIG. 3, an enlarged view of the optical device 100 of an eye-tracking system is shown. In some examples, the camera 118 of the eye-tracking system can be disposed in the nasal region of the wearer and directed at the eye of the wearer. As shown in FIG. 3, the platform 120 and the camera 118 can be located on a nasal region 300 of the frame 106. As shown in FIG. 3, the nasal region 300 is the portion of the frame 106 that sits adjacent to a side of a user's nose during use. This location provides a close and unobstructed view of the user's eye, without substantially modifying the frame or disrupting the optical sight picture of the user. The camera can be configured specifically for eye-tracking and can include properties to reduce the weight and improve the accuracy of the smart eyeglass system. For example, the camera 118 can include a lens having a diameter between about 2 mm and about 4 mm. In some examples, the small diameter of the camera 118 allows proper positioning of the camera 118 in the nasal region 300 and/or near the nose bridge 114 of the assembly 104. In an example, the lens diameter can be defined as the diameter of a front glass element of the camera's lens. The camera lens can be designed to redirect light onto an imaging device. The diameter of a lens relates to the focal length, aperture, and how well defined the final image can be. In some aspects, the larger the lens the more light can be redirected to the camera. A larger lens can provide a better image quality, but also adds to the weight of the assembly 104. The lens of the camera can be optimized to provide the required range and field to capture the eye motions of the wearer for the required eye-tracking. The lens is also sized to reduce or minimize any effects on obscuring the vision of the wearer. In other words, the camera includes a size to reduce or minimize any obstruction of the lens 108 by the anatomy of the user during use.

In some examples, the camera 118 can include a resolution between about 320 pixels and about 640 pixels. Camera resolution can be determined by the pixel size, lens aperture, magnification, Nyquist limit, and other parameters. The pixels capture light in a digital image. Smaller pixels each receive less light than large ones, so will always individually be noisier. However, when images are scaled and or processed, the difference can be significant. In other words, the images captured by the camera 118 require a resolution for the processor (e.g., processor 130) to analyze and perform the eye-tracking, without being overly aggressive of using power and/or storage space.

In some examples, the camera 118 can include an infrared camera. In some examples, a near-infrared light can be directed towards the center of the eyes (pupil), causing detectable reflections in both the pupil and the cornea. The reflections that are the vector between the cornea and the pupil can then be tracked by the infrared camera. In some examples, an infrared light source 132 can be included in the assembly 104. The light source 132 can emit an infrared light towards the eye of a wearer 102, and then the light can be reflected by the eye of the wearer back towards the camera 118 for capture and analysis. Although this example has been described with reference to a single infrared light source 132, multiple infrared sources 132 included in the assembly 104 are possible.

The accuracy of gaze direction measurement can be dependent on a clear demarcation and/or detection of the pupil, as well as the detection of corneal reflection. The infrared or near-infrared light can provide contrast between the pupil and the cornea. Light sources in the visible range do not provide as much contrast as the infrared light, therefore accuracy can be harder to achieve without infrared light. In some examples, for eye-tracking, a narrow band of near-infrared (“IR”) light can be required for eye imaging. Light from the visible spectrum can generate an uncontrolled specular reflection, while infrared light allows for a precise differentiation between the pupil and the iris. Infrared light directly enters the pupil and reflects off the iris. Additionally, as infrared light is not visible to humans the infrared light does not cause distractions while the eyes are being tracked.

In some examples, the electronic component 122 can be disposed in the frame 106 of the assembly 104 near the temple of the wearer 102. The electronic component 122 can be connected to either the first securement arm 110 or the second securement arm 112 as shown in FIG. 3. Further, in some examples, the electronic component 122 can include a first electronic component (e.g., battery 124) located in the second securement arm 112 and the assembly 104 can include a second electronic component located in the nose bridge 114 or other suitable location.

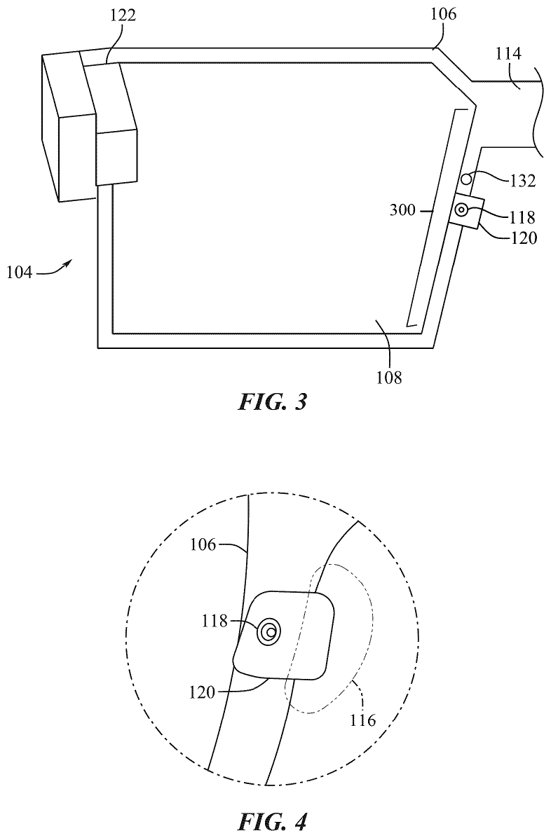

Any of the features, components, and/or parts, including the arrangements and configurations thereof shown in FIG. 3 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 3. Further details of the present eye-tracking systems and methods are provided below with reference to FIGS. 4-7.

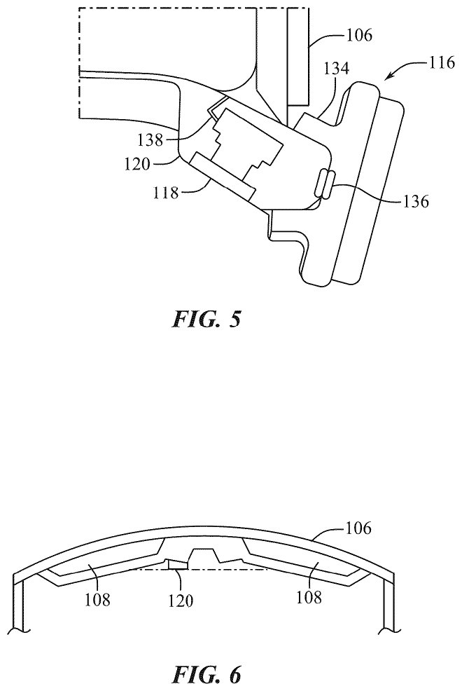

FIG. 4 shows eye-tracking camera 118 mounted to the platform 120 extending from the lens frame 106. The camera 118 is mounted adjacent the nose pad 116. In some examples, the nose pad 116 can be interchangeable. As described in more detail below, the eye-tracking system can be calibrated to the wearer. In some examples, the calibration can be simplified and/or improved by having interchangeable nose pads 116. For example, the eye-tracking system can be partially calibrated during the manufacture of the assembly 104. The eye-tracking camera 118 can be installed and directed to a direction most likely to be accurate for a wearer. However, due to differing face shapes and other physiology, the eye-tracking system may not be adjusted for each wearer. Further customization can be required. The interchangeable nose pads 116 can further customize the fit of the optical device 100. In some examples, the nose pads 116 can include features to improve grips of the nose pads 116. The nose pads 116 can be larger or smaller as required by the wearer. In some examples, the nose pads 116 can be elongated so that the assembly 104 is aligned higher on the face with respect to the eyes of the wearer. The interchangeability of the nose pads 116 can include various embodiments as described below in reference to FIG. 5.

FIG. 5 shows a cross-sectional view of the eye-tracking camera 118 of FIG. 4 and the nose pad 116. In some examples, the nose pad 116 can include at least one feature configured to secure the nose pad 116 to the platform 120 and/or the lens frame 108. The nose pad 116 can include a clamp 134 and/or a magnet 136. In one aspect, the nose pad 116 can include a snap feature to secure the nose pad 116 to the platform 120. In some configurations, the nose pad 116 can clamp to the platform 120 such that the platform 120 is disposed between two arms extending from the nose pad 116 and pressed between the arms to hold the nose pad 116 securely. In some examples, the magnets 136 can be included to retain the nose pad 116.

In some examples, the eye-tracking camera 118 can also be interchangeable. The camera can be installed during manufacture but may need to be replaced. The platform 120 can include a removable cover to access the camera 118. In some examples, the wearer and/or manufacturer can alternate between an infrared and standard camera. The camera 118 can also be removed for repairs and reinstalled. In some examples, the optical device can include a connector 138 that connects the camera 118 to the electronic component 122 (e.g., processor 130). The connector 138 can include a wire, a flexible printed circuit board, a receptacle, or other suitable connector. In some examples, the camera 118, the nose pad 116, and the connector are disposed within the platform 120. The platform 120 can be configured to improve the images captured by the camera 118.

Referring to FIG. 6, a top view of the optical device 100 is shown. In some examples, the platform 120 extending from the lens frame 106 towards the eye of the wearer. The platform 120 can extend such that a distance between the camera 118 and a surface of the eye during use is less than a distance between an inner surface of the lens 108 and the surface of the eye. In other words, the platform extends beyond the lens 108 disposed in the frame 106. In some examples, the lens 108 can be a prescription lens. When the vision prescription is particularly strong such that more vision correction is required (e.g., greater than −6.00 diopters or +6.00 diopters) the thickness of the lens 108 can be significant. Without the platform 120, a portion of the lens 108 can occlude or interfere with the camera 118. In some examples, the platform 120 can be configured to extend beyond the lens 108 as required by the user so that the field of view of the camera 118 is not impeded. In some examples, the thickness of the platform 120 can be adjusted. However, the nose pad 116 can also be adjusted to ensure the comfort of the smart eyeglass system for the wearer is not affected and the appropriate angle for determining the gaze point of the eye is maintained.

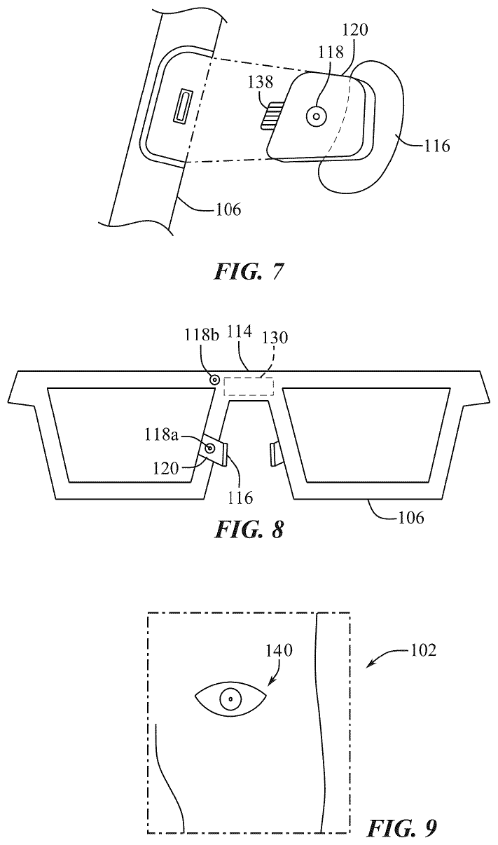

FIG. 7 shows an enlarged view of the lens frame 106 of the optical device 100 with the platform 120 being removably connected to the lens frame 106. In some examples, to ensure the camera 118 is positioned as required, the platform 120 can be interchangeable. In some examples, the platform 120 can include a clamp, a snap, or a magnet to secure the platform to the lens frame 106. The platform 120 can include various types of cameras. In some examples, a first platform can include an infrared camera and a second platform can include a standard camera. In other examples, the platform 120 can be interchanged with another platform 120 that extends further towards the face of the wearer. In some examples, a first platform can include a first camera having an angle of orientation that can be interchanged for a second platform including a second camera with a different angle of orientation. The platform 120 can include connector 138. In some examples, the connector 138 can extend from the platform and be configured to mate with a receptacle within the lens frame 106. In some examples, the platform 120 can also include a nose pad 116. The nose pad 116 can be adjustable for a customizable fit to the face of the wearer. Having the platform 120 be interchangeable can make the calibration more straightforward. In some examples, the platform 120 can include components optimized at the manufacturer for a fit and can reduce re-calibrations required by the wearer and/or fine-tuning adjustments. For example, the platform 120 and nose pad 116 can have a fixed orientation such that the camera angle can be better controlled.

Any of the features, components, and/or parts, including the arrangements and configurations thereof shown in FIGS. 4-7 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 4-7. Further details of the present eye-tracking systems and methods are provided below with reference to FIG. 8.

FIG. 8 shows a back view of the optical device 100 with an eye-tracking system including a first camera 118a and a second camera 118b disposed in the frame 106 of the optical device 100. The first camera 118a and the second camera 118b can be disposed in the nasal region defined by the frame 106. The processor 130 is also shown disposed in the frame 106. The eye-tracking system can include at least one camera positioned proximate the nose bridge 114 of the frame 106. While the eye-tracking system is unobtrusive, in some examples, the ocular device 100 can include more than one camera. The ideal location for imaging the eye is directly in front of the eye. A first camera 118a and a second camera 118b can be coordinated to better map the eye than a single camera. In some examples, the first camera 118a can be directed at a first eye and the second camera can be directed at a second eye. In other examples, both the first camera 118a and the second camera 118b can be directed at the same eye. In yet other examples, the first camera 118a can include an infrared camera and the second camera 118b can include a standard camera.

In some examples, the first camera 118a can be mounted to the platform 120 extending from the lens frame 106. The second camera 118b can be disposed in the frame 106 defining the nasal region near the nose bridge 114 as shown in FIG. 8. In some examples, the second camera 118b can be mounted in a second platform extending from the lens frame 106 opposite the first platform, or in other words, on the other side of the nose. In some examples, both the first camera 118a and the second camera 118b can be electronically connected to the processor 130 disposed within the frame 106. The processor can be disposed in the nose bridge 114, but other locations and arrangements are considered. The first camera 118a and the second camera 118b can cooperate to improve eye-tracking capability of the eye-tracking system.

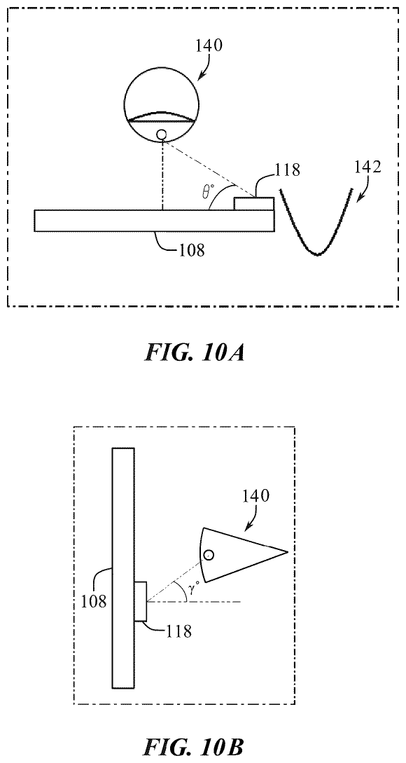

Any of the features, components, and/or parts, including the arrangements and configurations thereof shown in FIG. 8 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 8. Further details of the present eye-tracking systems and methods are provided below with reference to FIGS. 9-10.

FIG. 9 shows a front view of a user's eye 140 from a camera facing a wearer of a smart eyeglass system. In some examples, the smart eyeglass system can be calibrated to a face of the wearer. In some examples, calibration of the eye-tracking system can involve capturing a plurality of eye measurements. Each eye measurement can relate to a corresponding eye gaze position of the eye 140 of the wearer. The calibration can provide statistics data from the plurality of eye gaze measurements. In some examples, comparing the statistics of eye gaze measurements with statistics relating to pre-measured eye gaze positions of either the wearer or other persons can determine an appropriate fit for the eye-tracking system.

Calibration of the eye-tracking system can be conducted using several methods. In one example, a local recalibration of an eye tracker system can be conducted by manually moving an indicator (e.g., a mouse pointer) across a screen. The wearer can stare at the indicator while clicking on the mouse, causing all eye gazes recorded on the vicinity of the point to be calibrated as gazes at the actual point. Calibrations can be as few as a single, centered target, but more commonly are 5, 9, or even 13 points. The algorithm creates a mathematical translation between eye position and gaze position for each target, then can create a matrix to cover the entire calibration area with an interpolation in between each point. The more targets used, the higher and more uniform the accuracy will be across the entire visual field. The calibration area defines the highest accuracy part of the eye-tracking system's range, with accuracy falling if the eye 140 moves at an angle larger than the points used.

Another example can include transmitting data in a direction in which a viewer is looking with higher resolution than data offset from the direction in which a viewer is looking. The resolution distribution of a transmitted image can be dynamically altered accordingly so that a viewer has the impression of looking at a uniformly high-resolution image as they scan the image. In some examples, data from multiple modes can be combined to resolve ambiguities in tracking data. For example, a combination of eye-tracking system data and data from the wearer can provide statistics that greatly improves accuracy. In some examples, the eye-tracking system can be first calibrated at the manufacturer using data collected from other users and then “fine-tuned” to calibrate the eye-tracking system to the wearer. For example, a series of options included in the eye-tracking system can be developed for a first face shape, either determined by statistics or by measurements provided by a wearer. The eye-tracking system can then be further calibrated either by the wearer or the provider of the eye-tracking system to the unique face shape of the wearer.

FIG. 10A shows a top view of a wearer of the eye-tracking system and FIG. 10B shows a side view of a wearer of the eye-tracking system. In some examples, the camera can be positioned to capture the gaze of the wearer. For eye-tracking, an angle orientation between the camera 118 and the lens 108 of the optical device can include a compound angle that orients the camera from the nasal region towards the eye 140. The camera optical paths shown in FIGS. 10A-10B have advantages over other eye-tracking systems. The views of FIG. 10A-10B allow a more centered view of the eye 140, and because the camera does not pass through the eyepiece, there is no distortion caused by the lens 108. The camera 118 does look onto the eye 140 from a tilted position being in the nasal region, near the nose 142 of the wearer, which may cause reduced detection accuracy of eye features at extreme gaze angles due to distortion, insufficient depth-of-field, and occlusions (e.g., eye lashes). In some examples, the camera 118 can be oriented at an angle between about 30° and about 50° relative to the lens. In other words, the angle θ as shown in FIG. 10A can be the top view projected angle and can be between about 30° and about 50° relative to the lens for proper determination of the gaze point of the eye. In some examples, the angle θ can be about 50° or less, such as about 45° or less, about 40° or less, about 35° or less, about 30° or less, or in ranges of about 30° to about 35°, about 35° to about 45°, or about 45° to about 50° relative to the lens 108. The angle γ as shown in FIG. 10B can be the side view projected angle and can be between about 0° and about 30° relative to the horizontal plane perpendicular to the lens for proper determination of the gaze point of the eye. In some examples, the angle γ can be about 30° or less, such as about 20° or less, about 15° or less, about 10° or less, or in ranges of about 0° to about 15°, about 15° to about 20°, or about 20° to about 30° relative to a horizontal plane extending perpendicular to the lens 108 at the height of the camera 118.

To the extent applicable to the present technology, personal information data may be gathered to improve the present systems and methods. However, if gathered, the personal information data should be gathered, stored, and accessed according to well-established privacy policies and/or privacy practices. Additionally, the present exemplary systems and methods can be performed without the collection or use of personal information data.

The foregoing description, used specific nomenclature to provide a thorough understanding of the described embodiments. However, the specific details are not required in order to practice the described embodiments and were merely provided for purposes of illustration and description. Rather, many modifications and variations are possible in view of the above teachings.

What is claimed is:

1. An optical device, comprising:
a first securement arm;
a second securement arm;
a lens frame defining a lens aperture and including a nose bridge, the lens frame connected to the first securement arm and the second securement arm;
an eye-tracking camera mounted to a platform extending from the lens frame, the platform disposed proximate the nose bridge; and
an electronic component disposed in the lens frame, the electronic component electronically connected to the camera.

2. The optical device of claim 1, wherein the electronic component comprises a battery, a sensor, a communication module, or a processor.

3. The optical device of claim 2, wherein the electronic component is disposed in the nose bridge.

4. The optical device of claim 1, further comprising a lens disposed in the lens aperture, the lens including an inner surface;
wherein the eye-tracking camera extends farther than the inner surface of the lens towards an eye during use.

5. The optical device of claim 1, further comprising a nose pad connected to the platform.

6. The optical device of claim 5, the nose pad further comprising an interchangeable nose pad including a clamp, a snap, or a magnet.

7. The optical device of claim 1, wherein the platform is removably connected to the lens frame.

8. The optical device of claim 1, wherein the electronic component comprises a processor configured to receive an image from the eye-tracking camera and calculate a gaze point of an eye based on the image.

9. An eye-tracking system, comprising:
an optical device including a frame defining a nasal region and a lens;
a camera disposed in the nasal region; and
a processor connected to the camera, the processor configured to receive an image from the camera and identifies a property of an eye based on the received image.

10. The eye-tracking system of claim 9, wherein:
the camera comprises a first camera; and
further comprising a second camera disposed in the nasal region.

11. The eye-tracking system of claim 9, the camera comprising an infrared camera.

12. The eye-tracking system of claim 9, wherein the camera is oriented at a horizontal angle between about 30° and about 50° relative to the lens and a center of an eye during use.

13. The eye-tracking system of claim 9, wherein the camera is oriented at a vertical angle between about 0° and about 30° relative to the lens and a center of an eye during use.

14. The eye-tracking system of claim 9, the camera comprising a resolution between about 320 and about 640 pixels.

15. The eye-tracking system of claim 9, the camera comprising a lens having a diameter between about 2 mm and about 4 mm.

16. The eye-tracking system of claim 9, wherein the processor is disposed in the frame.

17. A head mounted display (HMD), comprising:
a frame defining a platform in a nasal region of the frame, the platform extending from the nasal region;
a lens disposed in the frame;
a nose pad secured to the frame;
a camera mounted to the platform adjacent the nose pad; and
a sensor responsive to an eye movement of the wearer.

18. The HMD of claim 17, wherein the lens comprises a prescription lens.

19. The HMD of claim 17, wherein the platform and the nose pad are calibrated to a face of the wearer.

20. The HMD of claim 17, further comprising a processor connected to the camera;
wherein the processor receives an image from the camera and determines the gaze point of an eye.
